(19) United States
(12) Patent Application Publication
(10) Pub. No.: US 2026/0171563 A1
(43) Pub. Date: Jun. 18, 2026

(54) MANUFACTURING APPARATUS OF BATTERY CELL

(71) Applicant: MAZDA MOTOR CORPORATION, Hiroshima (JP)

(72) Inventors: Shun KUWAKO, Hiroshima (JP); Taiki YOSHIMURA, Hiroshima (JP); Takanori KAJIMOTO, Hiroshima (JP); Shinichi SHIMIZU, Hiroshima (JP); Hideaki KAWAGUCHI, Hiroshima (JP); Kosaku ITO, Hiroshima (JP)

(73) Assignee: MAZDA MOTOR CORPORATION, Hiroshima (JP)

(21) Appl. No.: 19/409,019

(22) Filed: Dec. 4, 2025

(30) Foreign Application Priority Data
Dec. 18, 2024 (JP) 2024-222365

(51) Int. Cl. H01M 50/169; B29C 65/20; B29L 31/34; H01M 50/121

(52) U.S. Cl. CPC H01M 50/169; B29C 65/20; H01M 50/121; B29L 2031/3468

(57) ABSTRACT

An apparatus to weld resin pieces of a battery together during manufacture of a battery cell includes a first hot plate that pressurizes and heats exterior materials forming a container of the battery cell and resin pieces in a layering direction at a position of an opening of the container, thereby sealing the opening. A second hot plate pressurizes and heats edges of the exterior materials stacked in the layering direction at least in the layering direction, thereby sealing an edge portion of the container.

### TECHNICAL FIELD

A technique disclosed herein relates to manufacturing a battery cell.

### BACKGROUND

Japanese Patent Laid-Open No. 2009-272161 describes a conventional laminated battery. The laminated battery is a battery in which an electrode body is housed in an exterior member. The laminated battery includes a plurality of current-collecting terminals that are drawn out from the electrode body to the outside of the exterior member. The plurality of current-collecting terminals are stacked with thermoplastic resin pieces interposed therebetween. At the periphery of the exterior member, the resin pieces are welded to each other and to the exterior member, thereby closing the periphery of the exterior member from which the current-collecting terminals are drawn out.

In the laminated battery, each of the plurality of current-collecting terminals is drawn out to the outside of the exterior member. The plurality of current-collecting terminals are not connected to each other in the exterior member. In the laminated battery, the space in the exterior member can be used to expand the electrode body. The structure of the laminated battery is advantageous for improving the energy density of the battery.

### SUMMARY

The above-described laminated battery is manufactured by a heat sealing process. In the heat sealing process, the stacked resin pieces at the periphery of the exterior member are welded together by being pressed by the hot plate, which is an energy supply source, in the stacking direction. In addition, the exterior members stacked on the lateral side of the resin pieces and at the periphery of the exterior members are also joined together through a heat sealing process using a hot plate.

When the number of current collectors drawn out of the exterior material increases due to increase in the number of electrodes layered in the battery cell, the number of resin pieces welded together in the heat sealing process increases. FIG. 7 illustrates an example of a manufacturing apparatus 90 of a battery cell in which a large number of resin pieces 5 are to be welded together. FIG. 7 shows a cross section corresponding to an opening 19 of a container 10. The container 10 is formed by stacking sheet-like exterior materials 11 and welding the edges of the exterior materials 11 together in the layering direction (i.e., the up-down direction on the paper surface in FIG. 7). The container 10 houses an electricity generation element therein. Reference numerals 30 denote current collectors 30 of the electricity generation element, and the current collectors 30 protrude outside the container 10 through the opening 19. Note that the opening 19 of the container 10 herein means an opening through which the current collectors 30 are drawn out. The part where the edges of the exterior materials 11 are welded together is not included in the opening 19.

Since the number of resin pieces 5 is large, the thickness T of the opening 19 is significantly thicker than the thickness of the welded part of the edges of the exterior materials 11. Here, thickness T is the distance from the upper end of opening 19 to the edge portion of the exterior material 11. A corner 18 is formed between a lateral part of the opening 19 and the welded part of the edges of the exterior materials 11 adjacent to the lateral part.

If the welding of the resin pieces 5 and the welding of the edges of the exterior materials 11 are performed simultaneously, the manufacturing man-hours for the battery cell can be reduced. Each hot plate 99 to be used for hot plate welding of the resin pieces 5 may be shaped to have a recess 98 to match the shape of the battery cell. The depth D of the recess 98 is set in advance to correspond to the thickness T of the opening 19, and the width W of the recess 98 is set in advance to correspond to the width of the opening 19.

However, in the hot plate 99, the pressurizing force and temperature required at the part where a large number of layered resin pieces 5 are welded together differ from the pressurizing force and temperature required at the part where the edges of the exterior materials 11 are welded together. It is difficult for the hot plate 99 to appropriately weld both the large number of layered resin pieces 5 together and the edges of the exterior materials 11 together.

In addition, since a large number of resin pieces 5 are layered, it is conceivable to set the depth D and the width W of the recess 98 to be larger in advance, taking into account the variation in the shape of the resin pieces 5. However, if the size of the recess is made larger, a gap occurs between the resin pieces 5 and the exterior materials 11 during hot plate welding, and the opening 19 may not be stably sealed.

Furthermore, a hot plate 99 with the recess 98 of a fixed size can only be used to manufacture battery cells of the same shape. For example, if the number of layered electrodes in the battery cell is different, the thickness T of the opening 19 changes. The hot plate 99 having the recess 98 of the depth D cannot be used to manufacture battery cells having openings 19 with different thicknesses T. The hot plate 99 having the recess 98 has low versatility.

The technique disclosed herein appropriately welds resin pieces together during manufacture of a battery cell.

The technique disclosed herein relates to a manufacturing apparatus of a battery cell.

The battery cell includes a container, a plurality of current collectors, and resin pieces, the container housing an electricity generation element in which a plurality of electrodes are stacked in a layering direction, the plurality of current collectors each being connected to a corresponding one of the electrodes in the container, the current collectors each protruding outside the container through an opening of the container in a state in which the current collectors are stacked in the layering direction, the resin pieces each being welded to a corresponding one of the current collectors between the adjacently stacked current collectors to seal the opening of the container.

The container, having the opening, is formed by welding edges of exterior materials together, the exterior materials being stacked in the layering direction.

The disclosed apparatus for manufacturing the battery cell includes:
a first hot plate that pressurizes and heats the exterior materials and the resin pieces in the layering direction at a position of the opening of the container, and thereby seals the opening; and
a second hot plate that pressurizes and heats the edges of the exterior materials, stacked in the layering direction, at least in the layering direction on lateral sides of the resin pieces at a position of the opening of the container, and thereby welds edges of the exterior materials together.

In the battery cell, each of the plurality of stacked current collectors protrudes outside the container through the opening of the container. The plurality of current collectors are connected to electrodes with the same polarity, for example. Inside the container, the plurality of current collectors are not connected to each other. The connection space between the current collectors inside the container can be omitted. The electrodes of the battery cell can be expanded by using the space inside the container. The battery cell of this structure can have a high energy density.

The opening of the container is sealed with resin pieces. The resin pieces are, for example, thermoplastic resin pieces. The container, having the opening, is formed by welding edges of exterior materials together, the exterior materials being stacked in the layering direction. The opening of the container here is a part through which the current collector protrudes and is a part sealed with the resin pieces. The part where the edges of the exterior materials are welded together is not included in the opening of the container.

The manufacturing apparatus of the battery cell welds the exterior materials and the resin pieces together, and welds the edges of the exterior materials together.

The first hot plate pressurizes and heats the exterior materials and the resin pieces in the layering direction at the position of the opening of the container. In order to weld the plurality of stacked resin pieces together, the first hot plate is required to apply a relatively high pressurizing force and a relatively high temperature.

The second hot plate pressurizes and heats the edges of the exterior materials in the layering direction on the lateral side of the resin pieces at the position of the opening of the container. Since the second hot plate welds the edges of the exterior materials together to seal an edge portion of the container, the second hot plate is required to apply a relatively low pressurizing force and a relatively low temperature.

The manufacturing apparatus welds different parts of the battery cell using the first hot plate and the second hot plate. The pressurizing force and the temperature of the first hot plate can be optimized, and the pressurizing force and the temperature of the second hot plate can be optimized. The manufacturing apparatus can appropriately perform welding during manufacturing the battery cell. Furthermore, since the manufacturing apparatus described above can simultaneously weld different parts of the battery cell using the first hot plate and second hot plate, the manufacturing apparatus makes it possible to reduce the manufacturing man-hour.

It is also possible that a corner is formed between a lateral part of the opening and an edge portion of the container;
the first hot plate moves in the layering direction to pressurize the exterior materials and the resin pieces in the layering direction; and
the second hot plate has a first surface to be in contact with a lateral part of the opening and a second surface to be in contact with the edge portion of the container, and moves in a diagonal direction toward the opening with respect to the layering direction to pressurize the exterior materials both in a direction perpendicular to the layering direction and in the layering direction.

The layered product in which the plurality of resin pieces are stacked may have large dimensional variations. If there is a large dimensional variation, a gap may be generated between the resin pieces and the exterior materials in the layering direction or in the direction perpendicular to the layering direction at the opening of the container.

In contrast to this, in the manufacturing apparatus described above, the first hot plate moves in the layering direction. The first hot plate pressurizes the exterior materials and resin pieces in the layering direction, thereby allowing the plurality of resin pieces and exterior materials stacked in the opening to be appropriately welded together.

The second hot plate moves in a diagonal direction toward the opening with respect to the layering direction. The first surface of the second hot plate comes into contact with the lateral part of the opening and pressurizes the exterior materials in a direction perpendicular to the layering direction. The exterior materials are welded without gaps to the lateral parts of the resin pieces stacked in the opening. In the direction perpendicular to the layering direction, the occurrence of a gap between the resin pieces and the exterior materials is prevented. The second surface of the second hot plate comes into contact with the edge portion of the container and pressurizes the exterior materials in the layering direction. The edges of the exterior materials are appropriately welded together.

The second hot plate, which can move in a direction different from that of the first hot plate, works together with the first hot plate to prevent the opening of the container from occurrence of a gap, enabling the opening to be stably sealed.

The first hot plate may have a variable amount of movement relative to the second hot plate in the layering direction.

If the relative movement amount of the first hot plate is variable, the manufacturing apparatus of the battery cell can optimize the position of the first hot plate depending on the shape of the battery cell. The manufacturing apparatus can stably seal the openings of the containers for battery cells of various shapes. The manufacturing apparatus has versatility.

It is also possible that a temperature of the first hot plate is set to a first temperature; and a temperature of the second hot plate is set to a second temperature lower than the first temperature.

Since the first hot plate and the second hot plate are separate bodies, the temperature of the first hot plate and the temperature of the second hot plate can be optimized individually.

Since the second hot plate, which welds the edges of the exterior materials together, has a relatively low temperature, the second hot plate can prevent the exterior materials from being overheated.

It is also possible that a pressurizing force of the first hot plate is set to a first pressurizing force, and a pressurizing force of the second hot plate is set to a second pressurizing force lower than the first pressurizing force.

Since the first and second hot plates are separate bodies, the pressurizing force of the first hot plate and the pressurizing force of the second hot plate can be optimized individually.

Since the second hot plate, which welds the edges of the exterior materials together, has a relatively low pressurizing force, the second hot plate can prevent the exterior materials from being excessively pressurized.

It is also possible that a pressurizing and heating time of the first hot plate is set to a first time; and a pressurizing and heating time of the second hot plate is set to a second time shorter than the first time.

Since the first hot plate and the second hot plate are separate bodies, the pressurizing and heating time of the first hot plate and pressurizing and heating time of the second hot plate can be optimized individually.

The second hot plate, which welds the edges of the exterior materials together, has a relatively short pressurizing and heating time, so that the second hot plate can prevent the exterior materials from being excessively pressurized and heated.

It is also possible that the battery cell has first current collectors and second current collectors, the first current collectors each being connected to a negative electrode, the second current collectors each being connected to a positive electrode, a direction in which the first current collectors protrude outward through a first opening of the container being the same as a direction in which the second current collectors protrude outward through a second opening of the container; and
the manufacturing apparatus of the battery cell further includes a third hot plate that pressurizes and heats edges of the exterior materials, stacked in the layering direction, in the layering direction between the first opening and the second opening that are adjacent in a direction perpendicular to the layering direction, and thereby seals an edge portion of the container.

The third hot plate is required to apply a relatively low pressurizing force and a relatively low temperature, similarly to the second hot plate, to weld the edges of the exterior materials stacked together in the layering direction. The manufacturing apparatus of the battery cell includes the third hot plate in addition to the first hot plate and second hot plate, so that the manufacturing apparatus can optimize the pressurizing force and temperature of the third hot plate. The manufacturing apparatus described above can appropriately perform welding during manufacturing the battery cell, and can simultaneously and stably seal each of the first opening and the second opening.

The manufacturing apparatus of the battery cell described above can appropriately perform welding during manufacturing of the battery cell.

### BRIEF DESCRIPTION OF THE DRAWINGS

FIG. 1 is a cross-sectional view of a battery cell.

FIG. 2 is an exploded perspective view of the battery cell.

FIG. 3 shows a manufacturing apparatus of the battery cell.

FIG. 4 shows a manufacturing state of a battery cell in which the number of layered electrodes is different.

FIG. 5 shows a manufacturing state of a battery cell in which peripheries of the container is at a different position.

FIG. 6 shows a manufacturing apparatus for manufacturing a battery cell in which a first opening and a second opening are located side by side.

FIG. 7 shows a conventional manufacturing apparatus of a battery cell.

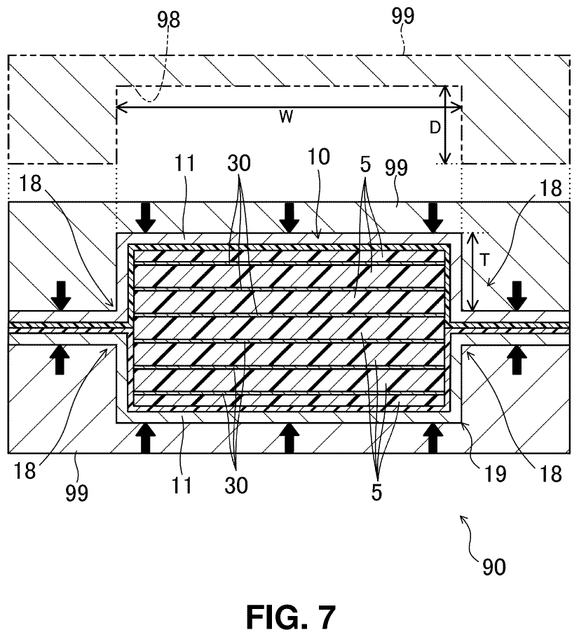

### DETAILED DESCRIPTION

Hereinafter, an embodiment of a manufacturing apparatus of a battery cell will be described with reference to the drawings. The manufacturing apparatus of the battery cell described here is an example.

### Battery Cell Structure

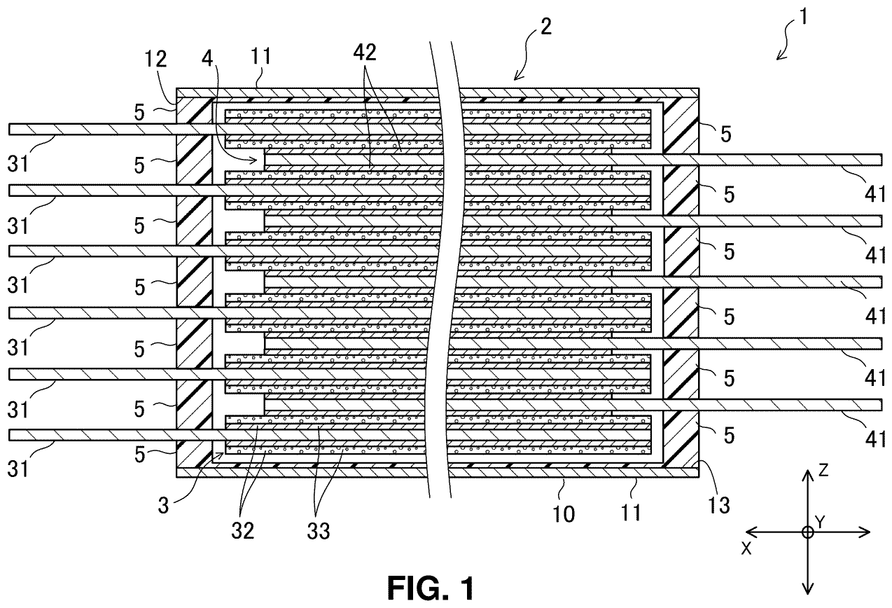

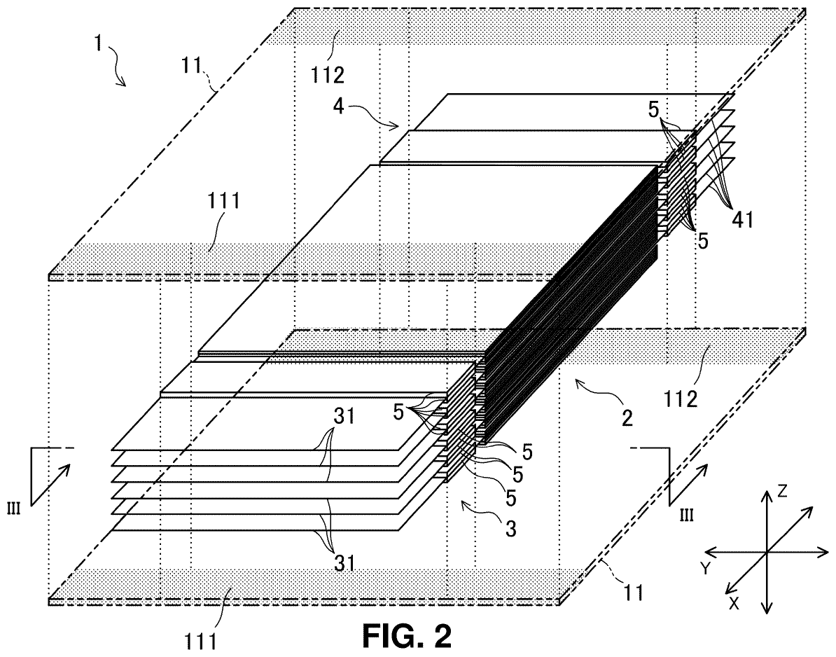

FIG. 1 schematically shows an overall structure of a battery cell 1. FIG. 2 is an exploded perspective view of the battery cell 1. More specifically, FIG. 2 is a perspective view of an electricity generation element 2 of the battery cell 1. In the following, the left-right direction on the paper surface in FIG. 1 is called an X-direction, the direction perpendicular to the paper in FIG. 1 is called a Y-direction, and the up-down direction on the paper surface in FIG. 1 is called a Z-direction. The Z direction corresponds to the layering direction described later, and the Y direction corresponds to the direction perpendicular to the layering direction.

The battery cell 1 is a secondary battery. The battery cell 1 is, for example, a lithium ion battery. The battery cell 1 is a so-called pouch-type battery. The battery cell 1 includes an electricity generation element 2 and a container 10. The container 10 is sealed with the electricity generation element 2 and the electrolyte contained therein. The container 10 is formed into a bag shape by folding one exterior material 11 or stacking two exterior materials 11 and sealing the edges. Each of the exterior materials 11 has a three-layer structure in which a metal layer is interposed between two resin layers. The metal layer is, for example, aluminum or stainless steel. The resin layer is made of, for example, polypropylene (PP) or polyethylene (PE).

The electricity generation element 2 has first electrode sheets 3. The first electrode sheets 3 are, for example, negative electrode sheets. The electricity generation element 2 has second electrode sheets 4. The second electrode sheets 4 are, for example, positive electrode sheets. The first electrode sheets 3 and the second electrode sheets 4 are alternately stacked. The numbers of the first electrode sheets 3 and the second electrode sheets 4 are optional in the electricity generation element 2. The electricity generation element 2 is an electrode-layered product. In the following, the direction in which the first electrode sheets 3 and the second electrode sheets 4 are layered may be referred to as the layering direction.

Each first electrode sheet 3 has a current collector 31. The current collector 31 is a thin plate material or a foil that extends in the X direction. An end of the current collector 31, that is, the left end in FIG. 1, protrudes outside the container 10 from the left opening 12 of the container 10.

A first surface and a second surface of each current collector 31 located inside the container 10 are coated with an active material. The first surface is the upper surface of the current collector 31 in FIG. 1, and the second surface is the lower surface of the current collector 31 in FIG. 1. The active material forms first electrodes 32. The current collector 31 is connected to the first electrodes 32 inside the container 10.

Each first electrode sheet 3 has separators 33. Each separator 33 separates the first electrode 32 of the first electrode sheet 3 from a second electrode 42 of the second electrode sheet 4, which will be described later. The separator 33 is, for example, a porous material through which ionic substances can pass.

Each separator 33 covers the surface of a corresponding one of the two first electrodes 32 in the first electrode sheet 3. The separator 33 may be formed by pasting a film forming the separator 33 to the first electrode 32. The separator 33 may also be formed by drying the slurry applied to the first electrode 32. The area of the separator 33 may be the same as or larger than the area of the first electrode sheet 3.

Each second electrode sheet 4 has a current collector 41. The current collector 41 is a thin plate material or a foil that extends in the X direction. An end of the current collector 41, that is, the right end in FIG. 1, protrudes outside the container 10 from the right opening 13 of the container 10. The right opening 13 is an opening opposite to the left opening 12 in the X direction. The protruding direction of the current collector 41 is not limited to the opposite direction to the protruding direction of the current collector 31.

A first surface and a second surface of each current collector 41 located inside the container 10 are coated with an active material. The active material forms second electrodes 42. The current collector 41 is connected to the second electrodes 42 inside the container 10.

As described above, the first electrode sheets 3 and the second electrode sheets 4 are alternately layered. The first electrodes 32 and the second electrodes 42 are stacked in the layering direction, that is, the Z direction, inside the container 10 via the separators 33.

The left opening 12 of the container 10 is sealed with resin pieces 5. Each resin piece 5 is a sealing material. The resin pieces 5 are located between the exterior materials 11 and the current collectors 31, and between the current collectors 31. Similarly, the right opening 13 is sealed with resin pieces 5. The resin pieces 5 are located between the exterior materials 11 and the current collectors 41, and between the current collectors 41.

The plurality of current collectors 31 are not connected to each other inside the container 10 and protrude individually outside the container 10. Similarly, the plurality of current collectors 41 are not connected to each other inside the container 10 and individually protrude outside the container 10. Inside the container 10, since the connection space of the current collectors 31 and 41 can be omitted, the areas of the first electrodes 32 and the second electrodes 42 can be increased by the omitted space. The battery cell 1 can have a high energy density.

### Method for Manufacturing Battery Cell

A method for manufacturing the battery cell 1 follows the procedure below. First, the first electrode sheets 3 and the second electrode sheets 4 are prepared. As described above, each first electrode sheet 3 has a current collector 31, first electrodes 32, and separators 33. The first electrode sheet 3 also has resin pieces 5 (see FIG. 2). Each resin piece 5 is located on the current collector 31 between the end of the current collector 31 and the first electrodes 32. Each resin piece 5 is welded in advance to a corresponding one of the first surfaces and second surfaces of the current collectors 31.

Each second electrode sheet 4 has a current collector 41, second electrodes 42, and resin pieces 5. Each resin piece 5 of the second electrode sheet 4 is located on the current collector 41 between the end of the current collector 41 and the second electrodes 42, similarly to the resin piece 5 of the first electrode sheet 3. Each resin piece 5 is welded in advance to a corresponding one of the first surfaces and second surfaces of the current collectors 41.

Next, the first electrode sheets 3 and the second electrode sheets 4 are layered alternately as shown in FIG. 2. The first electrodes 32 and the second electrodes 42 are stacked with the separators 33 interposed therebetween. The first electrode sheets 3 and the second electrode sheets 4 are layered to form the electricity generation element 2. At this time, the first electrode sheets 3 and the second electrode sheets 4 are layered with the current collectors 31 of the first electrode sheets 3 and the current collectors 41 of the second electrode sheets 4 protruding in opposite directions.

In each current collector 31 of the first electrode sheet 3, resin pieces 5 are located between the end of the current collector 31 and the electricity generation element 2. The resin pieces 5 are aligned in the layering direction. In each current collector 41 of the second electrode sheet 4, resin pieces 5 are also located between the end of the current collector 41 and the electricity generation element 2. The resin pieces 5 are aligned in the layering direction.

Each resin piece 5 is a thermoplastic resin piece. The resin piece 5 is made of a material selected from cast polypropylene (CPP), low density polyethylene (LDPE), linear low density polyethylene (LLDPE), high density polyethylene (HDPE), oriented polypropylene (OPP), polyethylene terephthalate (PET), or oriented nylon (ONY). The resin pieces 5 and the resin layers of exterior materials 11 may be made of the same resin.

After the electricity generation element 2 is formed, as shown imaginarily in FIG. 2, the exterior materials 11 are placed on the electricity generation element 2. First edges 111 in the X direction of the exterior materials 11, which are shaded in FIG. 2, are located at a position of the resin pieces 5 of the first electrode sheets 3. Second edges 112 in the X direction of the exterior materials 11 are located at a position of the resin pieces 5 of the second electrode sheets 4. The two edges of each exterior material 11 in the Y direction are each located outside a corresponding one of the ends of the electricity generation element 2.

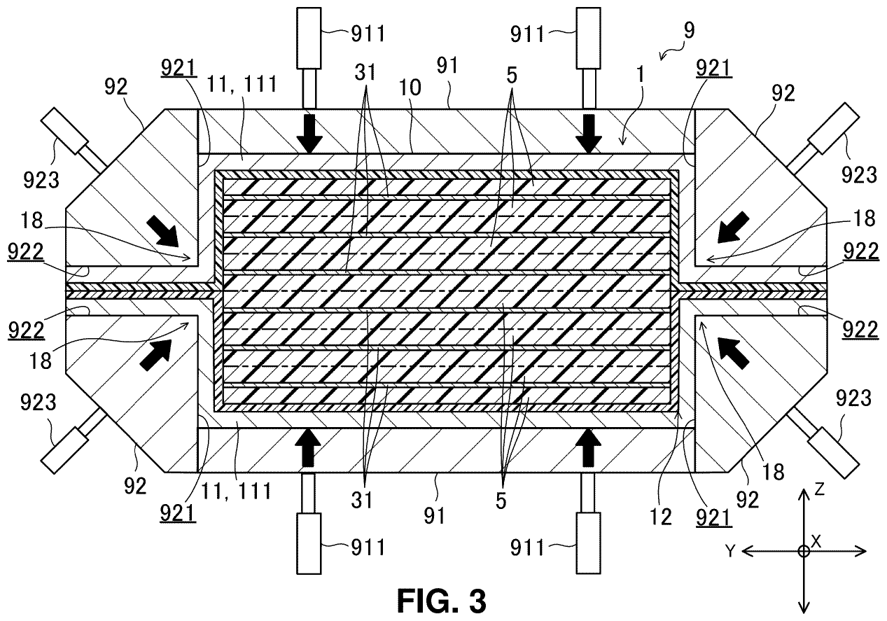

Next, the edges of the exterior materials 11 and the resin pieces 5 are welded together. FIG. 3 corresponds to a III-III cross-sectional view of FIG. 2. Here, the method for manufacturing the battery cell 1 will be described using the welding of the resin pieces 5 and the first edges 111 of the exterior materials 11 at the left opening 12 as an example, but the same applies to the welding of the resin pieces 5 and the second edges 112 of the exterior materials 11 at the right opening 13.

An apparatus 9 for manufacturing a battery cell 1 is an apparatus that performs hot plate welding. The manufacturing apparatus 9 includes first hot plates 91. The first hot plates 91 are hot plates that weld the resin pieces 5 and the exterior materials 11 together. More specifically, the first hot plates 91 pressurize and heat the first edges 111 of the exterior materials 11 and the resin pieces 5 in the layering direction at the position of the left opening 12 of the container 10. The width of each first hot plate 91 (width in the left-right direction on the paper surface in FIG. 3) corresponds to the width of the left opening 12.

In the Z direction, one first hot plate 91 is located outside the upper exterior material 11, and the other first hot plate 91 is located outside the lower exterior material 11. The first hot plates 91 pressurize the exterior materials 11 and the resin pieces 5 in the Z direction with hydraulic cylinders 911, 911 (see black arrows in FIG. 3). The hydraulic cylinders 911, 911 extend in the Z direction. Extending the hydraulic cylinders 911, 911 causes the first hot plates 91 to pressurize the first edges 111 of the exterior materials 11 and the resin pieces 5 in the Z direction. The hydraulic cylinders 911, 911 are an example of a pressurizing mechanism that generates a pressurizing force of the first hot plates 91. Each dash-dot-dot line in FIG. 3 imaginarily shows a boundary surface where the resin pieces 5 of the first electrode sheets 3 are welded together.

The battery cell 1 has a large number of current collectors 31, 41 stacked in the Z direction. Corners 18 are formed each between a lateral part of the opening 12 and an edge portion of the container 10 adjacent to the lateral part in the Y direction.

The manufacturing apparatus 9 includes second hot plates 92. The second hot plates 92 are hot plates that weld the first edges 111 of the exterior material 11 together. More specifically, the second hot plates 92 pressurize and heat, at least in the Z direction, the first edges 111 of the exterior materials 11 stacked in the Z direction, on the lateral sides of the resin pieces 5 at the position of the left opening 12 of the container 10. In the Z direction, part of the second hot plates 92 are located above the upper exterior material 11 and the rests are located below the lower exterior material 11. In the Y direction, part of the second hot plates 92 are located on a side of the first hot plates 91, and the rests are located on the opposite side of the first hot plates 91. The manufacturing apparatus 9 includes a total of four second hot plates 92.

Each second hot plate 92 has a first surface 921 and a second surface 922. The first surface 921 is a surface facing the Y direction and a surface to be in contact with a lateral part of the left opening 12. As described later, the first surfaces 921 pressurize the first edges 111 of the exterior materials 11 in the Y direction toward lateral parts of the stacked resin pieces 5. The second surface 922 is a surface facing the Z direction and a surface to be in contact with an edge portion of the container 10. As described later, the second surfaces 922 pressurize the first edges 111 of the exterior materials 11 in the Z direction.

The second hot plates 92 are independent of the first hot plates 91. Each second hot plate 92 has a pressurizing mechanism separate from the first hot plate 91. In other words, the pressurizing mechanism of the second hot plate 92 has a hydraulic cylinder 923. The extension direction of the hydraulic cylinder 923 is inclined with respect to the Z direction. The pressurization direction of the second hot plate 92 is different from the pressurization direction of the first hot plate 91.

More specifically, the extension direction of each hydraulic cylinder 923 is inclined toward the left opening 12 with respect to the Z direction. The first surfaces 921 of second hot plates 92 pressurize the exterior materials 11 toward the lateral parts of the left opening 12 by the extension of the hydraulic cylinders 923. The second surfaces 922 of second hot plates 92 pressurize the exterior materials 11 in the Z direction by extension the hydraulic cylinders 923.

The pressurizing force of each first hot plate 91 is set to a first pressurizing force. The first pressurizing force is a relatively high pressurizing force. The first hot plates 91 can sufficiently pressurize the plurality of resin pieces 5 and exterior materials 11 stacked in the Z direction.

The pressurizing force of each second hot plate 92 is set to a second pressurizing force. The second pressurizing force is a pressurizing force lower than the first pressurizing force. The second hot plates 92 appropriately pressurize the exterior materials 11 stacked in the Z direction without excessively pressurizing them.

The temperature of each first hot plate 91 is set to a first temperature. The first temperature is a relatively high temperature. Heat energy from the high-temperature first hot plates 91, 91 is transferred from the outside to the center in the layering direction through the exterior materials 11, resin pieces 5, and current collectors 31. Each of the plurality of resin pieces 5 stacked in the Z direction receives heat energy and melts.

The temperature of each second hot plate 92 is set to a second temperature. The second temperature is lower than the first temperature. Heat energy from the second hot plates 92 is transferred to the exterior materials 11, and the resin pieces on the back surfaces of the exterior materials 11 melt due to the received heat energy.

The pressurizing and heating time of the first hot plates 91 is set to a first time. The first time is a relatively long time. The first hot plates 91 can supply sufficient heat energy to each of the plurality of resin pieces 5 and the exterior materials 11 stacked in the Z direction.

The pressurizing and heating time of the second hot plates 92 is set to a second time. The second time is shorter than the first time. The second hot plates 92 can prevent supplying excessive heat energy to the exterior materials 11 stacked in the Z direction.

The manufacturing apparatus 9 welds different parts in the openings 12, 13 of the battery cell 1 together using the first hot plates 91 and the second hot plates 92. The pressurizing force, temperature, and time of each first hot plate 91 can be optimized, and the pressurizing force, temperature, and time of each second hot plate 92 can also be optimized. The above-described manufacturing apparatus 9 can appropriately perform welding during manufacturing a battery cell 1. In addition, the manufacturing apparatus 9 including the first hot plates 91 and the second hot plates 92 can simultaneously weld different parts in the openings 12, 13 of the battery cell 1, thereby reducing the manufacturing man-hours.

A layered product in which a plurality of resin pieces 5 are stacked may have large dimensional variations. If the dimensional variation is large, a gap may occur between the resin pieces 5 and the exterior materials 11 in the Y direction or Z direction in the openings 12, 13 of the container 10 during welding of the resin pieces 5 with manufacturing apparatus 9. The more resin pieces 5 are stacked, the more difficult it is to appropriately weld the resin pieces 5 and the exterior materials 11 together to stably seal the openings 12, 13.

In contrast to this, in the manufacturing apparatus 9, the first hot plates 91 can pressurize the exterior materials 11 and the resin pieces 5 in the Z direction independently of the second hot plates 92. The plurality of stacked resin pieces 5 and exterior materials 11 are appropriately welded together at the positions of the openings 12, 13.

The second hot plates 92 can also move in a diagonal direction with respect to the Z direction. The first surfaces 921 of the second hot plates 92 can weld the exterior materials 11 to the lateral parts of the resin pieces 5 stacked at the openings 12, 13 without any gaps. The second surfaces 922 of the second hot plates 92 can appropriately weld the edges of the exterior material 11 together. The second hot plates 92, which can move in a direction different from those of the first hot plates 91, can work together with the first hot plates 91 to prevent gaps from occurring in the openings 12, 13 of the container 10, stably sealing the openings 12, 13.

In this way, as shown in FIG. 3, the opening of the container 10 (here, the left opening 12) is sealed by the welded resin pieces 5. The manufacturing apparatus 9 can improve the sealing quality of the openings 12, 13 of the container 10.

In the manufacturing apparatus 9, the amount of movement of each first hot plate 91 relative to the second hot plate 92 in the Z direction is configured to be variable. The manufacturing apparatus 9 can stably seal the openings 12, 13 of the containers 10 for battery cells 1 of various shapes.

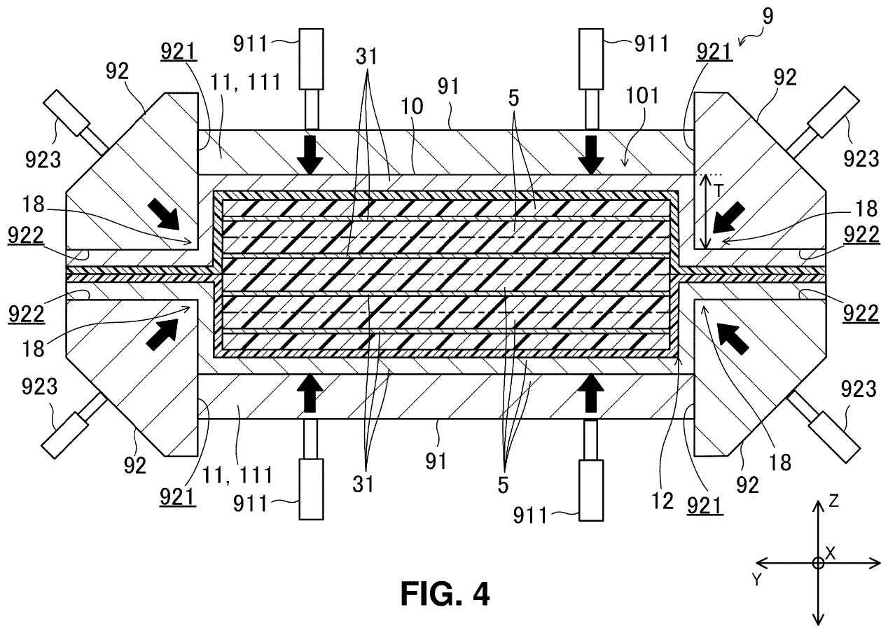

For example, FIG. 4 illustrates a manufacturing state of a battery cell 101 in which the number of layered electrode sheets 3, 4 is smaller compared to the battery cell 1 in FIG. 3. The thickness T of the openings 12, 13 of the container 10 is relatively thin. Since the first hot plates 91 have a variable relative movement amount, they can be positioned at a position corresponding to the thickness T of the openings 12, 13 and pressurize the first edges 111 of the exterior materials 11 and the resin pieces 5 in the Z direction. The manufacturing apparatus 9 can stably seal the openings 12, 13 of the container 10 even for battery cells 101 with different shapes.

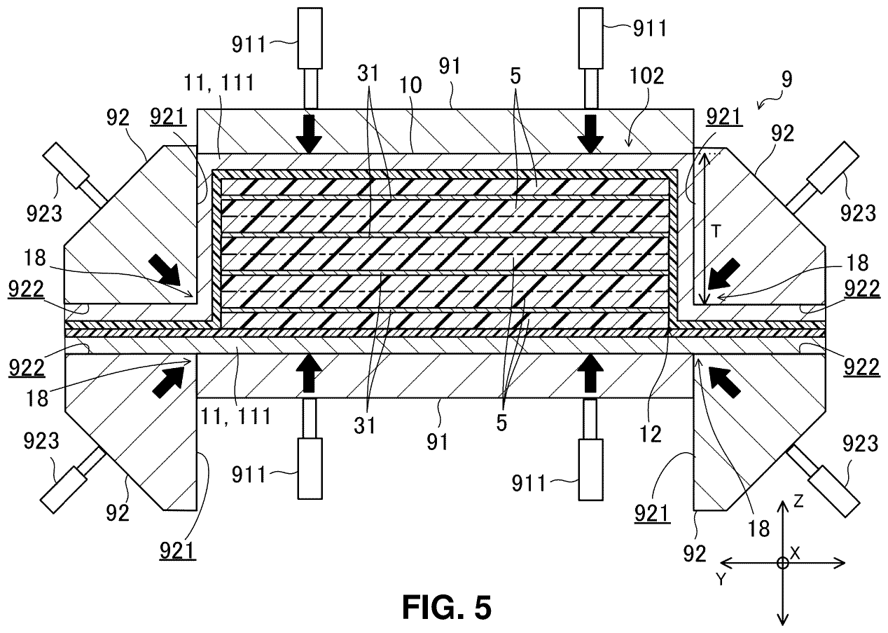

For example, FIG. 5 illustrates a manufacturing state of a battery cell 102 in which joint parts between the edges of the exterior materials 11 is located in a different position in the Z-direction compared to the battery cell 1 in FIG. 3. It can be said that the battery cell 102 has a different thicknesses T of the openings 12, 13 of the container 10. Note that, as described above, thickness T is the distance in the Z direction from the upper ends of openings 12, 13 to the edges of exterior material 11. Since the first hot plates 91 have a variable amount of movement relative to the second hot plates 92, they can be positioned at a position corresponding to the thickness T of the openings 12, 13 and pressurize the first edges 111 of the exterior materials 11 and the resin pieces 5 in the Z direction. The second hot plates 92 can pressurize the edges of the exterior materials 11, stacked in the Z direction on the lateral side of a first hot plate 91, in the Z direction, and can pressurize the exterior materials 11 in the Y direction toward the lateral parts of the stacked resin pieces 5. The manufacturing apparatus 9 can stably seal the openings 12, 13 of the container 10 even for battery cells 102 with different shapes.

The manufacturing apparatus 9, which includes the first hot plates 91 and the second hot plates 92 that are independent of each other, can manufacture battery cells 1 of various shapes and is highly versatile.

### Modifications

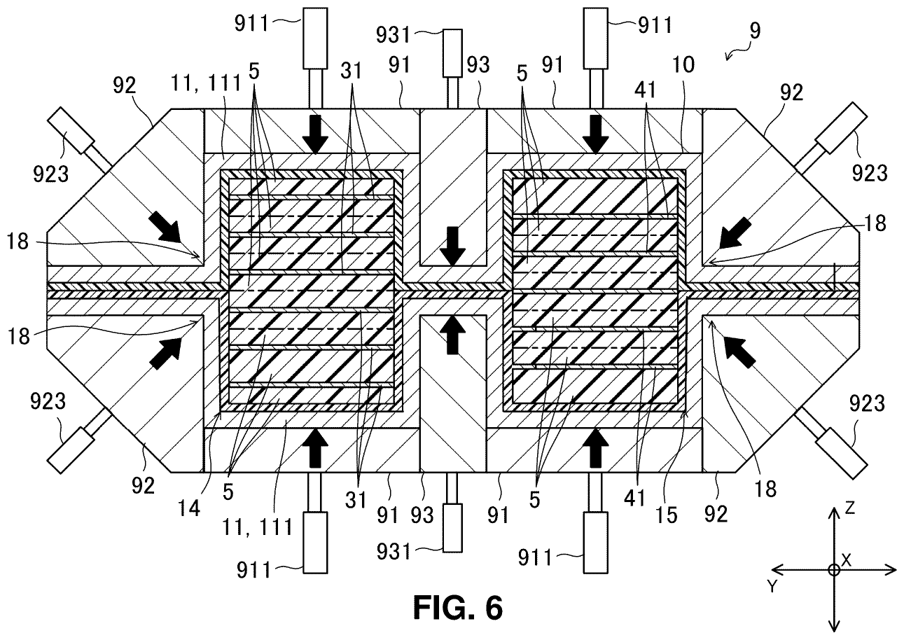

FIG. 6 shows a modification of the manufacturing apparatus 9. The manufacturing apparatus 9 in FIG. 6 includes third hot plates 93. In the battery cell 1 manufactured by the manufacturing apparatus 9 of FIG. 6, the current collectors 31 and the current collectors 41 protrude in the same direction in the battery cell 1. At the first end of the container 10 in the X direction, a first opening 14 from which the current collectors 31 protrude and a second opening 15 from which the current collectors 41 protrude are provided side by side in the Y direction. The container 10 has a welding portion, between the first opening 14 and the second opening 15, where the first edges 111 of the exterior materials 11 stacked in the Z direction are welded together.

Note that, in the manufacturing apparatus 9 of FIG. 6, the third hot plates 93 are interposed, so that each of the first hot plates 91 is separated into a first hot plate 91 corresponding to the first opening 14 and a first hot plate 91 corresponding to the second opening 15, but the first hot plate 91 may be one piece.

The third hot plates 93 pressurize and heat the first edges 111 of the exterior materials 11, stacked in the layering direction, in the Z direction between the first opening 14 and the second opening 15. The manufacturing apparatus 9 includes a pressurizing mechanism for the third hot plates 93. The pressurizing mechanism is hydraulic cylinders 931. The hydraulic cylinders 931 extend in the Z direction. Extension of the hydraulic cylinders 931 allows the third hot plates 93 to pressurize the first edges 111 of the exterior materials 11 in the Z direction.

The third hot plates 93 are independent of the first hot plates 91 and the second hot plates 92. The pressurizing force of each third hot plate 93 is set to a third pressurizing force. The temperature of the third hot plates 93 is set to a third temperature. The pressurizing and heating time of the third hot plates 93 is set to a third time. The pressurizing force, temperature, and time of each third hot plate 93 are optimized individually. Since the first hot plates 91, the second hot plates 92, and the third hot plates 93 are independent of each other, the manufacturing apparatus 9 can appropriately pressurize and heat different parts in the openings 14, 15 of the container 10. The manufacturing apparatus 9 can stably seal the openings 14, 15 of the container 10.

The above-described hydraulic cylinders 923 are an example of a pressurizing mechanism that generates a pressurizing force of the second hot plates 92. The pressurizing mechanism of the second hot plates 92 is not limited to the hydraulic cylinders 923. The pressurizing mechanism of the second hot plates 92 may employ a known cam mechanism. The cam mechanism converts the vertical pressurizing force into a direction inclined relative to the vertical direction. The cam mechanism allows the second hot plates 92 to be moved in a diagonal direction relative to the Z direction.

Note that the second hot plates 92 may be configured to move in the Z direction.

What is claimed is:

1. An apparatus for manufacturing a battery cell, the battery cell including a container, a plurality of current collectors, and resin pieces, the container housing an electricity generation element in which a plurality of electrodes are stacked in a layering direction, the plurality of current collectors each being connected to a corresponding one of the electrodes in the container, the current collectors each protruding outside the container through an opening of the container in a state in which the current collectors are stacked in the layering direction, the resin pieces each being welded to a corresponding one of the current collectors between the adjacently stacked current collectors to seal the opening of the container,
the container, having the opening, being formed by welding edges of exterior materials together, the exterior materials being stacked in the layering direction,
the apparatus comprising:
a first hot plate that pressurizes and heats the exterior materials and the resin pieces in the layering direction at a position of the opening of the container, and thereby seals the opening; and
a second hot plate that pressurizes and heats the edges of the exterior materials, stacked in the layering direction, at least in the layering direction on lateral sides of the resin pieces at a position of the opening of the container, and thereby seals an edge portion of the container.

2. The apparatus for manufacturing the battery cell according to claim 1, wherein
a corner is formed between a lateral part of the opening and an edge portion of the container,
the first hot plate moves in the layering direction to pressurize the exterior materials and the resin pieces in the layering direction, and
the second hot plate has a first surface to be in contact with a lateral part of the opening and a second surface to be in contact with the edge portion of the container, and moves in a diagonal direction toward the opening with respect to the layering direction to pressurize the exterior materials both in a direction perpendicular to the layering direction and in the layering direction.

3. The apparatus for manufacturing the battery cell according to claim 2, wherein
the first hot plate has a variable amount of movement relative to the second hot plate in the layering direction.

4. The apparatus for manufacturing the battery cell according to claim 1, wherein
a temperature of the first hot plate is set to a first temperature, and
a temperature of the second hot plate is set to a second temperature lower than the first temperature.

5. The apparatus for manufacturing the battery cell according to claim 2, wherein
a temperature of the first hot plate is set to a first temperature, and
a temperature of the second hot plate is set to a second temperature lower than the first temperature.

6. The apparatus for manufacturing the battery cell according to claim 3, wherein
a temperature of the first hot plate is set to a first temperature, and
a temperature of the second hot plate is set to a second temperature lower than the first temperature.

7. The apparatus for manufacturing the battery cell according to claim 1, wherein
a pressurizing force of the first hot plate is set to a first pressurizing force, and
a pressurizing force of the second hot plate is set to a second pressurizing force lower than the first pressurizing force.

8. The apparatus for manufacturing the battery cell according to claim 2, wherein
a pressurizing force of the first hot plate is set to a first pressurizing force, and
a pressurizing force of the second hot plate is set to a second pressurizing force lower than the first pressurizing force.

9. The apparatus for manufacturing the battery cell according to claim 3, wherein
a pressurizing force of the first hot plate is set to a first pressurizing force, and
a pressurizing force of the second hot plate is set to a second pressurizing force lower than the first pressurizing force.

10. The apparatus for manufacturing the battery cell according to claim 1, wherein
a pressurizing and heating time of the first hot plate is set to a first time, and
a pressurizing and heating time of the second hot plate is set to a second time shorter than the first time.

11. The apparatus for manufacturing the battery cell according to claim 2, wherein
a pressurizing and heating time of the first hot plate is set to a first time, and
a pressurizing and heating time of the second hot plate is set to a second time shorter than the first time.

12. The apparatus for manufacturing the battery cell according to claim 3, wherein
a pressurizing and heating time of the first hot plate is set to a first time, and
a pressurizing and heating time of the second hot plate is set to a second time shorter than the first time.

13. The apparatus for manufacturing the battery cell according to claim 1,
the battery cell having first current collectors and second current collectors, the first current collectors each being connected to a negative electrode, the second current collectors each being connected to a positive electrode, a direction in which the first current collectors protrude outward through a first opening of the container being the same as a direction in which the second current collectors protrude outward through a second opening of the container,
the apparatus further comprising a third hot plate that pressurizes and heats edges of the exterior materials, stacked in the layering direction, in the layering direction between the first opening and the second opening that are adjacent in a direction perpendicular to the layering direction, and thereby seals an edge portion of the container.

14. A method for manufacturing a battery cell, the battery cell including a container, a plurality of current collectors, and resin pieces, the container housing an electricity generation element in which a plurality of electrodes are stacked in a layering direction, the plurality of current collectors each being connected to a corresponding one of the electrodes in the container, the current collectors each protruding outside the container through an opening of the container in a state in which the current collectors are stacked in the layering direction, the resin pieces each being welded to a corresponding one of the current collectors between the adjacently stacked current collectors to seal the opening of the container, the container, having the opening, being formed by welding edges of exterior materials together, the exterior materials being stacked in the layering direction,
the method comprising:
using a first hot plate to pressurize and heat the exterior materials and the resin pieces in the layering direction at a position of the opening of the container, to seal the opening; and
using a second hot plate to pressurize and heat the edges of the exterior materials, stacked in the layering direction, at least in the layering direction on lateral sides of the resin pieces at a position of the opening of the container, to seal an edge portion of the container.

15. The method for manufacturing the battery cell according to claim 14, the method comprising:
forming a corner between a lateral part of the opening and an edge portion of the container,
moving the first hot plate in the layering direction to pressurize the exterior materials and the resin pieces in the layering direction, and
moving the second hot place in a diagonal direction toward the opening with respect to the layering direction to pressurize the exterior materials both in a direction perpendicular to the layering direction and in the layering direction, the second hot plate having a first surface to be in contact with a lateral part of the opening and a second surface to be in contact with the edge portion of the container.
